(19) United States
(12) Patent Application Publication
(10) Pub. No.: US 2013/0077973 A1
(43) Pub. Date: Mar. 28, 2013

(54) SPECTRALLY EFFICIENT MODULATION FOR AN OPTICAL-TRANSPORT SYSTEM

(71) Applicants: Chongjin Xie, Morganville, NJ (US); Gregory Raybon, Shrewsbury, NJ (US)

(72) Inventors: Chongjin Xie, Morganville, NJ (US); Gregory Raybon, Shrewsbury, NJ (US)

(73) Assignee: ALCATEL-LUCENT USA INC., Murray Hill, NJ (US)

(21) Appl. No.: 13/245,024

(22) Filed: Sep. 26, 2011

(51) Int. Cl. H04J 14/00; H04J 14/06; H04J 14/02

(52) U.S. Cl. 398/65; 398/43; 398/83; 398/79

(57) ABSTRACT

An optical transport system having an optical add-drop multiplexer configured to reduce inter-channel crosstalk by driving Mach-Zehnder pulse carvers in its optical transmitters with electrical drive signals whose swing range is smaller than voltage 2V_{π} of said Mach-Zehnder pulse carvers.

### BACKGROUND

1. Field

The invention(s) relates to optical communication equipment and, more specifically but not exclusively, to optical transmitters and add-drop multiplexers.

2. Description of the Related Art

This section introduces aspects that may help facilitate a better understanding of the invention(s). Accordingly, the statements of this section are to be read in this light and are not to be understood as admissions about what is in the prior art or what is not in the prior art.

An optical add-drop multiplexer (OADM) is an optical device that can be used, e.g., in a wavelength-division multiplexing (WDM) optical-transport system for multiplexing and routing different modulated carriers (wavelengths) into or out of a transport fiber. The terms “add” and “drop” in the name of this device refer to the capabilities of adding one or more new modulated carriers to an existing WDM signal and dropping (removing) one or more modulated carriers from that WDM signal, respectively. The dropped modulated carriers can be directed, e.g., to another network path or to an optical detector for demodulation and optical-to-electrical (O/E) conversion.

A reconfigurable OADM (ROADM) is a form of OADM that enables remote control of the set of added and dropped carriers without having to change any of the actual physical connections in the device or convert the various modulated carriers into the corresponding electrical signals and then back into new modulated carriers. In a colorless ROADM, any of its transponders has access to any wavelength channel, both on the drop side and on the add side of the ROADM. In different implementations, the functionality of a colorless ROADM can be realized using different wavelength-selective switching technologies, such as those based on MEMS (micro-electro-mechanical systems) switches, liquid-crystal switches, planar waveguide circuits, and tunable optical filters. However, when the spectral density of populated WDM channels is relatively high, certain designs of a colorless ROADM suffer from a relatively high level of inter-channel crosstalk.

### SUMMARY

Disclosed herein are various embodiments of an optical add-drop multiplexer (OADM) configurable to minimize inter-channel crosstalk by driving Mach-Zehnder pulse carvers in its optical transmitters with electrical drive signals whose swing range is set to be smaller than voltage 2V_{π} of said Mach-Zehnder pulse carvers.

According to one embodiment, provided is an apparatus having an optical multiplexer having first and second input ports and an output port; a first set of one or more optical transmitters, each configured to generate a respective modulated optical signal and direct said modulated optical signal to the first input port of the optical multiplexer; and a second set of one or more optical transmitters, each configured to generate a respective modulated optical signal and direct said modulated optical signal to the second input port of the optical multiplexer. The optical multiplexer is configured to multiplex the modulated optical signals received at the first and second input ports and direct a resulting multiplexed signal to the output port. At least one of said optical transmitters comprises a Mach-Zehnder modulator configured to generate a pulse train for the modulated optical signal generated by said optical transmitter; and a drive circuit configured to drive said Mach-Zehnder modulator. The apparatus further has a controller configured to cause said drive circuit to drive the Mach-Zehnder modulator with an electrical ac signal having a swing range that is smaller than voltage 2V_{π}, where V_{π} is a characteristic voltage of the Mach-Zehnder modulator equal to a voltage difference between a dc bias voltage for a null in a transfer function for the Mach-Zehnder modulator and a dc bias voltage for an adjacent maximum in the transfer function.

According to another embodiment, provided is a WDM method having the steps of: generating one or more first modulated optical signals using a first set of one or more optical transmitters; generating one or more second modulated optical signals using a second set of one or more optical transmitters; multiplexing the first and second modulated optical signals using an optical multiplexer having first and second input ports and an output port and configured to (i) receive the one or more first modulated optical signals at the first input port, (ii) receive the one or more second modulated optical signals at the second input port, and (iii) direct a resulting multiplexed signal to the output port; generating a pulse train for at least one of the modulated optical signals using a Mach-Zehnder modulator; and driving said Mach-Zehnder modulator with an electrical ac signal having a swing range that is smaller than voltage 2V_{π}.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a block diagram of a reconfigurable optical add-drop multiplexer (ROADM) according to one embodiment of the invention;

FIGS. 2A-2B graphically illustrate spectral characteristics of CSRZ (carrier-suppressed return-to-zero) signals corresponding to an individual optical transmitter in the ROADM of FIG. 1 according to one embodiment of the invention;

FIG. 3 shows a block diagram of an optical transmitter that can be used in the ROADM of FIG. 1 according to one embodiment of the invention;

FIG. 4 graphically illustrates the pulse-carving operation of a Mach-Zehnder modulator (MZM) in the optical transmitter of FIG. 3 according to one embodiment of the invention; and

FIG. 5 shows a block diagram of an optical transmitter that can be used in the ROADM of FIG. 1 according to another embodiment of the invention.

### DETAILED DESCRIPTION

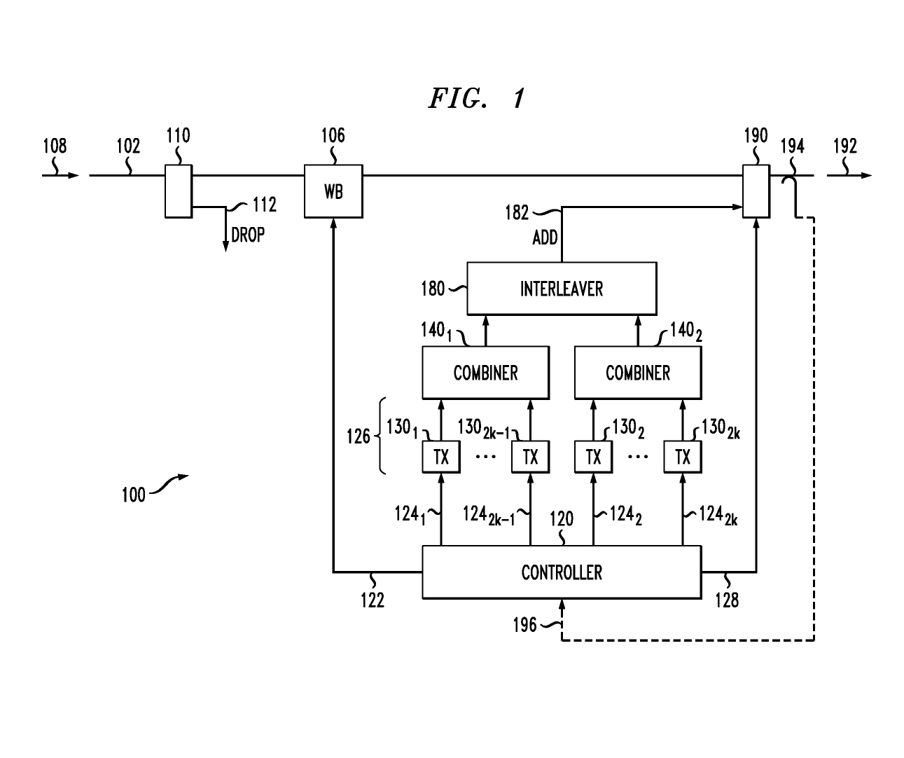

FIG. 1 shows a block diagram of a reconfigurable optical add-drop multiplexer (ROADM) 100 according to one embodiment of the invention. ROADM 100 is coupled to (i) an optical transport fiber 102 via an optical splitter 110 and (ii) an optical transport fiber 194 via an optical combiner 190. Optical splitter 110 is configured to split an incoming WDM signal 108 into two portions, with the first portion being directed to a wavelength blocker 106 and then to optical combiner 190 and the second portion being applied to an optical drop path 112 that can lead, e.g., to another transport fiber analogous to fiber 102 or to an input port of an optical receiver (not explicitly shown in FIG. 1). Wavelength blocker 106 is configured to block the carrier frequencies that are added via an add WDM signal 182. Optical combiner 190 is configured to combine the portion of WDM signal 108 that is transmitted by wavelength blocker 106 with add WDM signal 182, which is received by said optical combiner from an optical interleaver 180, thereby generating an outgoing WDM signal 192. ROADM 100 has a controller 120 that operates to configure wavelength blocker 106 and/or optical combiner 190, via control signals 122 and 128, respectively, so that there are no signal collisions at the output port of the optical combiner. As used herein, the term “signal collision” refers to an event in which optical combiner 190 receives two different modulated optical signals having the same carrier frequency, with one of said signals coming, via wavelength blocker 106, from optical splitter 110 and the other coming from interleaver 180.

In one embodiment, optical combiner 190 is implemented based on a 2×1 wavelength-selective switch (WSS). In an alternative embodiment, both optical splitter 110 and optical combiner 190 can be implemented based on wavelength-selective switches, with optical splitter 110 being implemented based on a 1×2 WSS and optical combiner 190 being implemented based on a 2×1 WSS. In certain embodiments, wavelength blocker 106 is optional and may be omitted. Representative wavelength-selective switches that can be used to implement optical splitter 110 and/or optical combiner 190 are disclosed, e.g., in U.S. Pat. Nos. 7,808,705, 7,468,840, 7,340,126, and 7,027,684, all of which are incorporated herein by reference in their entirety. When implemented with the use of a WSS, ROADM 100 may be a colorless ROADM.

Optical interleaver 180 is a 3-port passive device designed to combine two sets of wavelength channels (e.g., odd and even channels) in an interleaving way. For example, in one embodiment, optical interleaver 180 may be designed to take two sets of WDM channels with 100-GHz spacing and interleave them, thereby creating a denser set of WDM channels with 50-GHz spacing. Optical interleaver 180 may be implemented to operate based on multiple-beam interference using one or more of a birefringent crystal network, a Michelson interferometer, and a Gires-Tournois interferometer.

ROADM 100 has a set 126 of optical transmitters 130 configured to populate the wavelength channels of optical interleaver 180. Set 126 comprises two subsets having odd- and even-numbered transmitters 130, respectively. The odd-numbered transmitters 130₁-130₂ₖ₋₁ correspond to the odd wavelength channels of optical interleaver 180, where k is a positive integer greater than one. The even-numbered transmitters 130₂-130₂ₖ similarly correspond to the even wavelength channels of optical interleaver 180.

Each transmitter 130 is configured to generate a respective modulated optical signal to populate the corresponding wavelength channel. More specifically, transmitters 130₁-130₂ₖ₋₁ are configured to populate the odd wavelength channels, and transmitters 130₂-130₂ₖ are configured to populate the even wavelength channels. Using a respective control signal 124 and based on the current drop/add traffic requirements, controller 120 can turn ON or OFF each transmitter 130 as appropriate or necessary. An optical combiner 140₁ combines the individual modulated signals generated by transmitters 130₁-130₂ₖ₋₁ and applies the resulting optical WDM signal to a first input port of optical interleaver 180. An optical combiner 140₂ similarly combines the individual modulated signals generated by transmitters 130₂-130₂ₖ and applies the resulting optical WDM signal to a second input port of optical interleaver 180.

In one embodiment, each transmitter 130 is configured to generate the corresponding modulated signal using a CSRZ (carrier-suppressed return-to-zero) modulation format. In CSRZ, the electromagnetic-field intensity drops to zero between consecutive signaling intervals (symbol slots). The phase of the carrier alternates by π between neighboring symbol slots, so that, for example, if the relative phase is zero in even-numbered symbol slots, then the relative phase is π radians in odd-numbered symbol slots. The carrier pulse in each symbol slot can be further modulated using any suitable modulation format. For example, ON/OFF modulation may be used, in which the presence of a pulse in a symbol slot may encode a binary one, while the absence of a pulse in a symbol slot may encode a binary zero. QPSK (quadrature-phase shift keying) modulation may similarly be used.

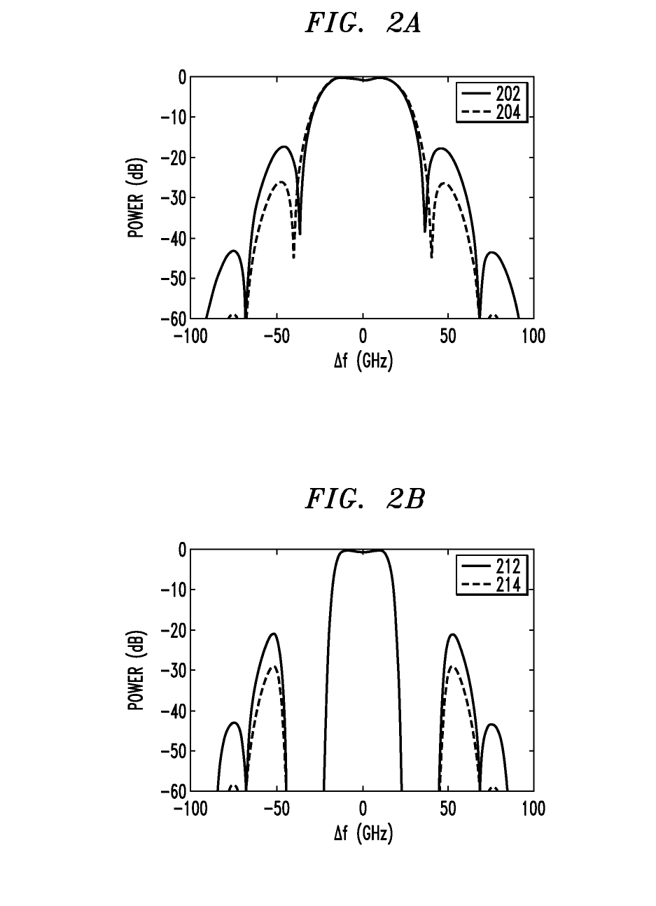

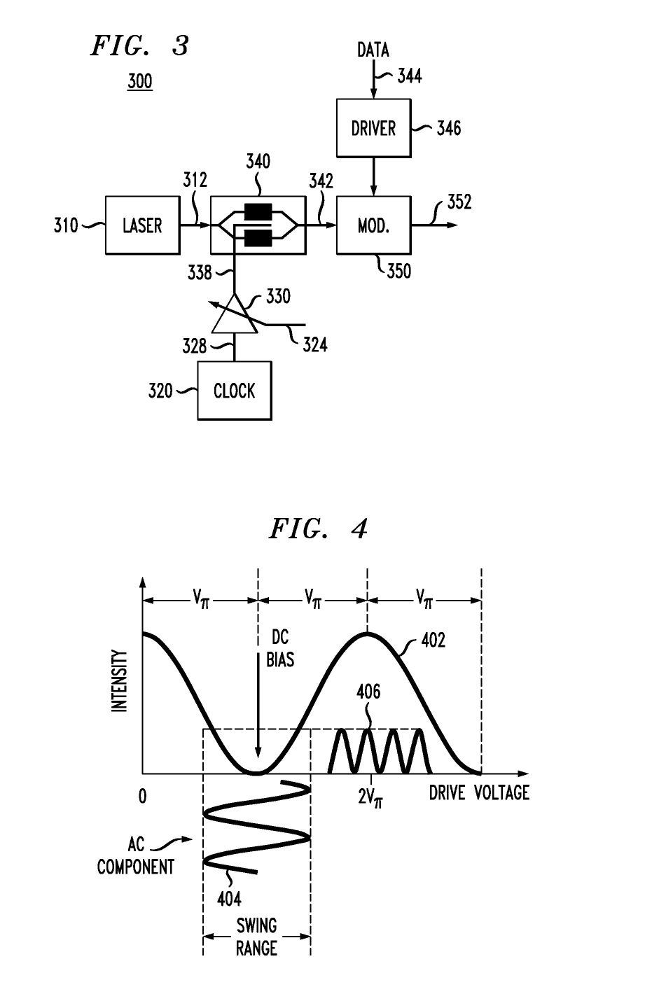

FIGS. 2A-2B graphically illustrate spectral characteristics of CSRZ signals corresponding to an individual transmitter 130 before and after optical interleaver 180, respectively, according to one embodiment of the invention. More specifically, spectra 202 (FIG. 2A) and 212 (FIG. 2B) correspond to one configuration of transmitter 130. A signal having spectrum 212 (FIG. 2B) is produced after a signal having spectrum 202 (FIG. 2A) passes through optical interleaver 180 and is subjected to band-pass filtering in the corresponding pass channel thereof. Spectra 204 (FIG. 2A) and 214 (FIG. 2B) correspond to another configuration of transmitter 130. A signal having spectrum 214 (FIG. 2B) is similarly produced after a signal having spectrum 204 (FIG. 2A) passes through optical interleaver 180 and is subjected to band-pass filtering in the corresponding pass channel thereof. The pertinent details of these two configurations are described in more detail below in reference to FIGS. 3 and 4.

Referring to FIG. 2A, both spectra 202 and 204 have a relatively flat main lobe, which is advantageous because a relatively large amount of optical power is concentrated near the carrier frequency (Δf=0). The side lobes of spectrum 202 have a higher intensity than the side lobes of spectrum 204. This difference in the side-lobe intensity is due to the different respective configurations of transmitter 130.

Referring to FIG. 2B, the main lobes of spectra 212 and 214 substantially coincide with one another and contain the useful power of the modulated signal. However, the side lobes of spectra 212 and 214 are significantly different and contain inter-channel crosstalk due to their spectral location in the spectral region where the main lobes of the modulated signals corresponding to the two immediately adjacent neighboring pass channels (not depicted in FIG. 2B) are spectrally located. Thus, the configuration of transmitter 130 that produces spectrum 214 is more beneficial due to the lower amount of inter-channel crosstalk.

FIG. 3 shows a block diagram of an optical transmitter 300 that can be used as optical transmitter 130 according to one embodiment of the invention. In two different configurations, optical transmitter 300 can generate the signals having spectra 202 and 204, respectively (see FIG. 2A).

Optical transmitter 300 has a Mach-Zehnder modulator (MZM) 340 configured to operate as a pulse carver. More specifically, MZM 340 transforms a CW light beam 312 generated by a laser 310 into a pulse train 342. Pulse train 342 is then subjected to modulation in an optical modulator 350. For example, based on a bit stream 344, a drive circuit 346 may drive modulator 350 to either block a pulse in pulse train 342 or let a pulse go through, thereby producing a modulated output signal 352. Other modulation formats, such as QPSK (quadrature-phase shift keying), may similarly be used to generate output signal 352 in optical modulator 350. Output signal 352 can then be applied, e.g., to the corresponding one of optical combiners 140₁ and 140₂ (see FIG. 1).

MZM 340 is driven by a drive signal 338 generated by a variable-gain amplifier 330. In one embodiment, the gain of amplifier 330 is set by a control signal 324, which can be, e.g., a corresponding one of control signals 124 (see FIG. 1). Drive signal 338 has a dc-bias component and an ac component, with the latter being generated by amplifying a clock signal 328 supplied by a clock circuit 320. Clock signal 328 has a rate that is one half of the symbol rate in output signal 352 and may employ different waveforms, such as a sinusoidal waveform or a saw-tooth waveform.

FIG. 4 graphically illustrates the pulse-carving operation of MZM 340 according to one embodiment of the invention. More specifically, a curve 402 shows a transfer function of MZM 340. Transfer function 402 has an approximately sinusoidal shape with maxima located at 0, 2V_{π}, 4V_{π}, etc., and nulls located at V_{π}, 3V_{π}, etc., where V_{π} is the characteristic voltage of MZM 340. The characteristic voltage V_{π} of MZM 340 is defined as the voltage difference between the drive voltage for a null and the drive voltage for an immediately adjacent maximum of transfer function 402.

In one configuration, MZM 340 may be driven by a drive signal that has (i) a dc-bias component corresponding to a null of transfer function 402, e.g., a dc-bias voltage of V_{π} as indicated in FIG. 4, and (ii) an ac component having a swing range that is smaller than 2V_{π}. Curves 404 and 406 in FIG. 4 illustrate this particular configuration. More specifically, curve 404 graphically shows the ac component of the drive signal. Curve 406 shows the intensity profile of the resulting pulse train. A known property of transfer function 402 is that the drive signals corresponding to its two adjacent lobes result in optical signals having a relative phase difference of π radians between them. Due to the fact that the ac component of the drive signal shown in FIG. 4 oscillates about a null of transfer function 402, two adjacent pulses in pulse train 406 have a relative phase shift of π radians. As a result, pulse train 406 is suitable for a CSRZ modulation format (also see the above-provided brief description of the CSRZ modulation format). In this particular configuration of MZM 340, optical transmitter 300 may generate output signal 352 having spectrum 204 (see FIG. 2A).

In another configuration, MZM 340 may be driven by a drive signal that has (i) a dc-bias component corresponding to a null of transfer function 402, e.g., a dc-bias voltage of V_{π} as indicated in FIG. 4, and (ii) an ac component having a swing range of 2V_{π} (not illustrated in FIG. 4). In this configuration of MZM 340, optical transmitter 300 may generate output signal 352 having spectrum 202 (see FIG. 2A).

In one embodiment, controller 120 (FIG. 1) may be configured to generate control signal 324 for optical transmitter 300 (FIG. 3) in a manner that minimizes the amount of inter-channel crosstalk at the output port of optical interleaver 180. Through experimentation, it has been found that, for most embodiments of ROADM 100 employing one or more transmitters 300, inter-channel-crosstalk reduction is optimized when the drive-signal swing range is set to a value between about 0.6 V_{π} and about 1.6 V_{π}. In particular, it has been determined that the inter-channel crosstalk may be minimized when the swing range is such that it is dominated by the approximately linear portions of transfer function 402 near its inflection points, which corresponds to a swing range of about V_{π}. Appropriate feedback loops may optionally be incorporated into ROADM 100, as known in the art and indicated in FIG. 1 by a dashed line 196, to enable controller 120 to track the amount(s) of inter-channel crosstalk in output signal 192 and adjust the swing range(s) accordingly, e.g., to minimize the crosstalk.

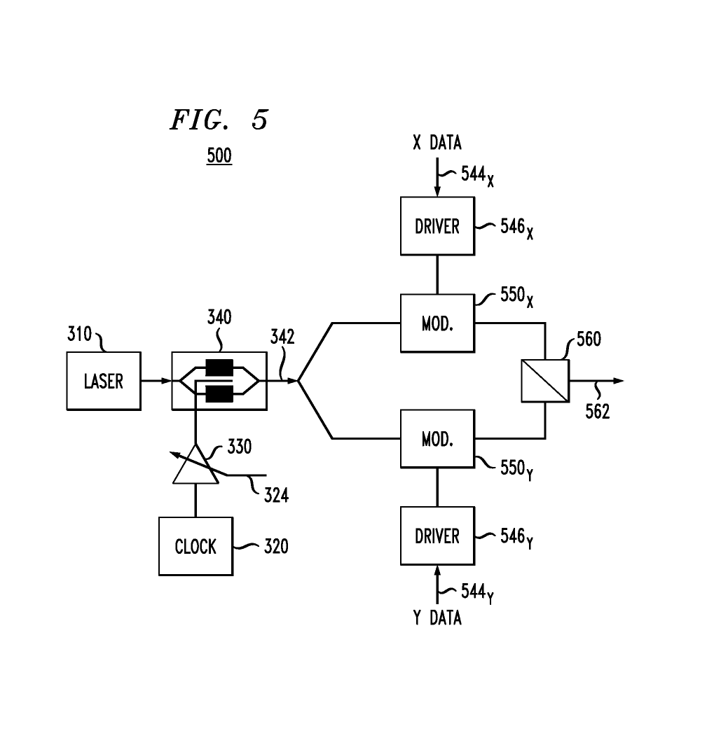

FIG. 5 shows a block diagram of an optical transmitter 500 that can be used as optical transmitter 130 according to another embodiment of the invention. Note that optical transmitter 500 and optical transmitter 300 (FIG. 3) have many of the same components. The description of these components is not repeated here. However, one difference between transmitters 300 and 500 is that the latter is designed to generate a polarization-division-multiplexed (PDM) output signal 562.

The PDM functionality of optical transmitter 500 is realized through the operation of two different optical modulators 550_{X} and 550_{Y}, both of which receive a corresponding (attenuated) copy of pulse train 342 generated by MZM 340 as already described above. Optical modulator 550_{X} is configured to generate an X-polarization component of output signal 562 by modulating its copy of pulse train 342 based on a bit stream 544_{X} and using a corresponding drive signal received from a drive circuit 544_{X}. Optical modulator 550_{Y} is similarly configured to generate a Y-polarization component of output signal 562 by modulating its copy of pulse train 342 based on a bit stream 544_{Y} and using a corresponding drive signal received from a drive circuit 544_{Y}. A polarization beam combiner 560 then appropriately combines the X- and Y-polarization components generated by optical modulators 550_{X} and 550_{Y}, respectively, to generate PDM output signal 562.

While this invention has been described with reference to illustrative embodiments, this description is not intended to be construed in a limiting sense.

For example, in one embodiment, the order in which MZM 340 and optical modulator 350 appear in the signal-propagation chain of optical transmitter 300 can be changed so that modulator 350 and its auxiliary circuits precede MZM 340 and its auxiliary circuits (see FIG. 3).

Although various embodiments of ROADM 100 (FIG. 1) have been described in reference to interleaver 180, certain embodiments may employ an optical multiplexer instead of said interleaver.

Various modifications of the described embodiments, as well as other embodiments of the invention, which are apparent to persons skilled in the art to which the invention pertains are deemed to lie within the principle and scope of the invention as expressed in the following claims.

For the purposes of this specification, a MEMS device is a device having two or more parts adapted to move relative to one another, where the motion is based on any suitable interaction or combination of interactions, such as mechanical, thermal, electrical, magnetic, optical, and/or chemical interactions. MEMS devices are fabricated using micro- or smaller fabrication techniques (including nano-fabrication techniques) that may include, but are not necessarily limited to: (1) self-assembly techniques employing, e.g., self-assembling monolayers, chemical coatings having high affinity to a desired chemical substance, and production and saturation of dangling chemical bonds and (2) wafer/material processing techniques employing, e.g., lithography, chemical vapor deposition, patterning and selective etching of materials, and treating, shaping, plating, and texturing of surfaces. The scale/size of certain elements in a MEMS device may be such as to permit manifestation of quantum effects. Examples of MEMS devices include, without limitation, NEMS (nano-electromechanical systems) devices, MOEMS (micro-opto-electromechanical systems) devices, micromachines, microsystems, and devices produced using microsystems technology or microsystems integration.

Unless explicitly stated otherwise, each numerical value and range should be interpreted as being approximate as if the word “about” or “approximately” preceded the value of the value or range.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

What is claimed is:

1. An apparatus, comprising:
an optical multiplexer having first and second input ports and an output port;
a first set of one or more optical transmitters, each configured to generate a respective modulated optical signal and direct said modulated optical signal to the first input port of the optical multiplexer;
a second set of one or more optical transmitters, each configured to generate a respective modulated optical signal and direct said modulated optical signal to the second input port of the optical multiplexer, wherein:
the optical multiplexer is configured to multiplex the modulated optical signals received at the first and second input ports and direct a resulting multiplexed signal to the output port; and
at least one of said optical transmitters comprises:
a Mach-Zehnder modulator configured to generate a pulse train for the modulated optical signal generated by said optical transmitter; and
a drive circuit configured to drive said Mach-Zehnder modulator; and
a controller configured to cause said drive circuit to drive the Mach-Zehnder modulator with an electrical ac signal having a swing range that is smaller than voltage 2V_{π}, where V_{π} is a characteristic voltage of the Mach-Zehnder modulator equal to a voltage difference between a dc bias voltage for a null in a transfer function for the Mach-Zehnder modulator and a dc bias voltage for an adjacent maximum in the transfer function.

2. The apparatus of claim 1, wherein the apparatus is an optical add-drop multiplexer.

3. The apparatus of claim 2, wherein the controller is further configured to:
receive a feedback signal from an output port of the optical add-drop multiplexer; and
based on said feedback signal, set the swing range so as to control crosstalk at said output port between spectrally adjacent modulated optical signals.

4. The apparatus of claim 1, wherein the controller is further configured to cause said drive circuit to bias the Mach-Zehnder modulator with a dc voltage corresponding to a null of the Mach-Zehnder modulator, wherein the electrical ac signal is superimposed on said dc voltage.

5. The apparatus of claim 4, wherein the controller is further configured to cause said drive circuit to drive the Mach-Zehnder modulator so that the swing range is smaller than the characteristic voltage V_{π}.

6. The apparatus of claim 1, wherein:
at least one of the first and second sets has at least two optical transmitters; and
the optical multiplexer is an optical interleaver configured to multiplex the modulated optical signals received at the first and second input ports in an interleaving manner.

7. The apparatus of claim 6, wherein:
the optical interleaver has a first set of wavelength channels corresponding to optical paths between the first input port and the output port, said first set of wavelength channels having a first inter-channel spacing;
the optical interleaver further has a second set of wavelength channels corresponding to optical paths between the second input port and the output port, said second set of wavelength channels having the first inter-channel spacing; and
the optical interleaver is configured to combine the first and second sets of wavelength channels so that the resulting multiplexed signal has an inter-channel spacing of about one half of the first inter-channel spacing.

8. The apparatus of claim 6, wherein the optical interleaver is configured to subject each of the modulated optical signals to bandpass filtering to reduce a spectral width of a main lobe of the modulated optical signal.

9. The apparatus of claim 6, further comprising:
a first optical combiner configured to combine the modulated optical signals generated by the first set of optical transmitters and apply a resulting first combined signal to the first input port of the optical interleaver; and
a second optical combiner configured to combine the modulated optical signals generated by the second set of optical transmitters and apply a resulting second combined signal to the second input port of the optical interleaver.

10. The apparatus of claim 1, wherein the controller is configured to cause the electrical ac signal to have a swing range between about 0.6 V_{π} and 1.6 V_{π}.

11. The apparatus of claim 1, wherein the at least one of said optical transmitters is configured to generate the modulated optical signal for a polarization component of a polarization-division-multiplexed signal.

12. The apparatus of claim 1, further comprising an optical combiner configured to couple said resulting multiplexed signal into an optical output fiber.

13. The apparatus of claim 12, wherein the optical combiner is implemented based on a wavelength-selective switch.

14. The apparatus of claim 12, further comprising an optical splitter configured to couple out of an optical input fiber at least a first portion of a received WDM and direct at least a second portion to the optical combiner.

15. The apparatus of claim 14, further comprising a wavelength blocker disposed between the optical splitter and the optical combiner, wherein the controller is further configured to control operation of at least one of the wavelength blocker and the optical combiner and also of the optical transmitters so as to avoid signal collisions in the optical output fiber between the modulated optical signals and the second portion of the received WDM signal.

16. A WDM method, comprising:
generating one or more first modulated optical signals using a first set of one or more optical transmitters;
generating one or more second modulated optical signals using a second set of one or more optical transmitters;
multiplexing the first and second modulated optical signals using an optical multiplexer having first and second input ports and an output port and configured to (i) receive the one or more first modulated optical signals at the first input port, (ii) receive the one or more second modulated optical signals at the second input port, and (iii) direct a resulting multiplexed signal to the output port;
generating a pulse train for at least one of the modulated optical signals using a Mach-Zehnder modulator; and
driving said Mach-Zehnder modulator with an electrical ac signal having a swing range that is smaller than voltage 2V_{π}, where V_{π} is a characteristic voltage of the Mach-Zehnder modulator equal to a voltage difference between a dc bias voltage for a null in a transfer function for the Mach-Zehnder modulator and a dc bias voltage for an adjacent maximum in the transfer function.

17. The method of claim 16, wherein the step of driving comprises:
biasing the Mach-Zehnder modulator with a dc voltage corresponding to a null of the Mach-Zehnder modulator; and
superimposing the electrical ac signal and said dc voltage.

18. The method of claim 16, wherein the electrical ac signal has a swing range between about 0.6 V_{π} and 1.6 V_{π}.

19. The method of claim 16, wherein the step of driving comprises setting the swing range so as to control crosstalk between spectrally adjacent multiplexed modulated optical signals.

20. The method of claim 16, wherein:
at least one of the first and second sets has at least two optical transmitters; and
said multiplexing comprises multiplexing the first and second modulated optical signals in an interleaving manner
